(19) United States
(12) Patent Application Publication
(10) Pub. No.: US 2025/0052480 A1
(43) Pub. Date: Feb. 13, 2025

(54) REFRIGERATOR DOOR HANDLE

(71) Applicant: Hisense USA Corporation, Suwanee, GA (US)

(72) Inventors: David Gold, Suwanee, GA (US); Heng Tong Pit, Suwanee, GA (US)

(73) Assignee: Hisense USA Corporation, Suwanee, GA (US)

(21) Appl. No.: 18/769,331

(22) Filed: Jul. 10, 2024

Related U.S. Application Data
(60) Provisional application No. 63/512,904, filed on Jul. 10, 2023.

(51) Int. Cl. F25D 23/02; E05B 1/00

(52) U.S. Cl. CPC F25D 23/028; E05B 1/0015; F25D 2323/02

(57) ABSTRACT

A refrigerator door has an inner surface that faces rearward toward an interior compartment of the refrigerator and a front, outer surface opposite the inner surface. A peripheral edge surface of the door is disposed between the inner and outer surfaces. A pocket handle extends along at least a portion of the peripheral edge surface of the door, where the pocket handle defines a recessed surface. A handle assembly includes a mounting portion that is attached to the recessed surface of the pocket handle. The mounting portion extends forward and supports a handle portion at a spaced distance forward from the outer surface of the door.

### CROSS-REFERENCE TO RELATED APPLICATION

This application claims benefit and priority under 35 U.S.C. § 119 (e) to U.S. Provisional Patent Application No. 63/512,904, filed Jul. 10, 2023, the content of which is considered part of this application and is hereby incorporated by reference in its entirety.

### TECHNICAL FIELD

The present disclosure relates generally to door structures and assemblies for refrigerator appliances, and more specifically to refrigerator door handles, handle assemblies, subassemblies, and components thereof.

### BACKGROUND

Refrigerator appliances generally include one or more refrigerator doors, such as vertically mounted doors that enclose chilled compartments for food and beverage storage and the like. The refrigerator doors are typically opened about a hinged connection to access the chilled compartments with the use of a handle associated with the respective door. Some refrigerators include freezer compartments that are enclosed with a vertically mounted door that commonly forms the front face of a food storage drawer that slides into the freezer compartment. Door handles may be mounted on the front surface of the refrigerator doors. Alternatively, some refrigerator door handles are incorporated into the refrigerator doors as pocket handles.

### SUMMARY

This disclosure provides a door assembly for a refrigerator appliance that includes a door body having an inner surface that is configured to face rearward toward an interior compartment of the refrigerator appliance. An outer surface of the door body is disposed opposite the inner surface and a peripheral edge surface is disposed between the inner surface and the outer surface of the door body. A pocket handle extends along at least a portion of the peripheral edge surface of the door body. The pocket handle defines a recessed surface. A handle assembly includes a mounting portion that is coupled with the recessed surface of the pocket handle. The handle assembly also includes a handle portion, where the mounting portion extends forward and supports the handle portion at a spaced distance forward from the outer surface of the door body.

The handle portion of the handle assembly may extend along a portion of a length of the pocket handle. The recessed surface of the pocket handle may include a front internal surface along an edge portion of a front wall of the door body that faces rearward on the door body, a rear internal surface along an intermediate wall of the door body that faces forward on the door body, and a connecting internal surface between the front and rear internal surfaces. A width of the front internal surface may be less than a width of the rear internal surface to position an edge of the front wall inboard from the peripheral edge surface of the door body.

The mounting portion of the handle assembly may include a fastener that extends through the connecting internal surface into the door body. The mounting portion of the handle assembly may include an internal section that extends in a width direction of the door body along the front internal surface of the pocket handle. Further, the mounting portion of the handle assembly may include an external section that extends forward from the internal section adjacent to and beyond an edge of the front wall. The external section of the mounting portion of the handle assembly may be disposed inboard in the width direction from the peripheral edge surface of the door body.

Another aspect of the disclosure provides a refrigerator appliance that includes a cabinet defining an interior compartment with an opening. A door is rotatably mounted to the cabinet and is operable to at least partially conceal the opening in a closed position. The door has an inner surface that faces the interior compartment, an outer surface opposite the inner surface, and a peripheral edge surface between the inner surface and the outer surface. A pocket handle extends at least partially along the peripheral edge surface of the door, where the pocket handle defines a recessed surface. A handle assembly has a handle portion and a mounting portion coupled with the recessed surface of the pocket handle. The mounting portion extends outward from the interior compartment and supports the handle portion at a spaced distance outward from the outer surface of the door.

Each of the above independent aspects of the present disclosure, and those aspects described in the detailed description below, may include any of the features, options, and possibilities set out in the present disclosure and figures, including those under the other independent aspects, and may also include any combination of any of the features, options, and possibilities set out in the present disclosure and figures.

The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is a perspective view of a refrigerator appliance having side-by-side doors that each include a door handle assembly.

FIG. 1A is a front view of the refrigerator appliance shown in FIG. 1.

FIG. 2 is a cross-sectional view of the refrigerator appliance shown in FIG. 1.

FIG. 3 is a front view of a refrigerator appliance having French doors that each include a door handle assembly.

FIG. 4 is a partial side view of an inside edge of a left refrigerator shown in FIG. 3.

FIG. 5 is a cross-sectional view of the refrigerator doors shown in FIG. 3.

FIG. 6 is an enlarged view of a door handle in section VI shown in FIG. 5.

Like reference numerals indicate like parts throughout the drawings.

### DETAILED DESCRIPTION

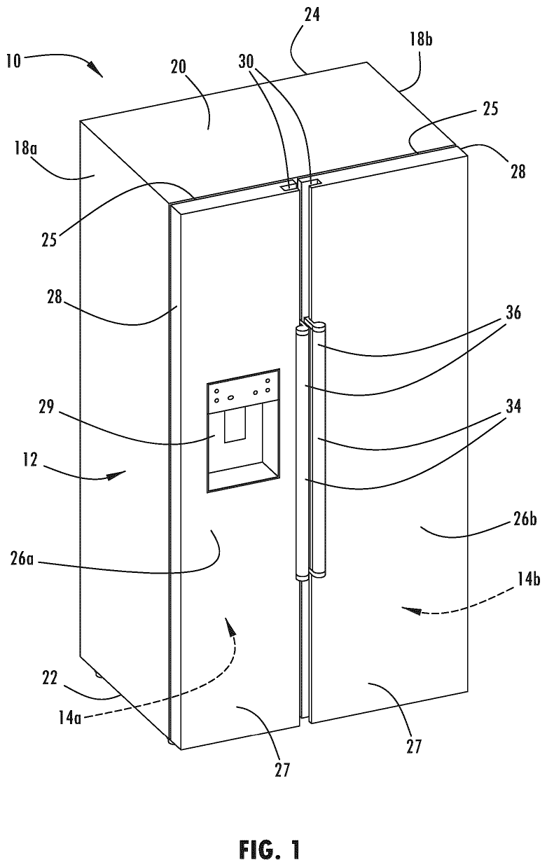

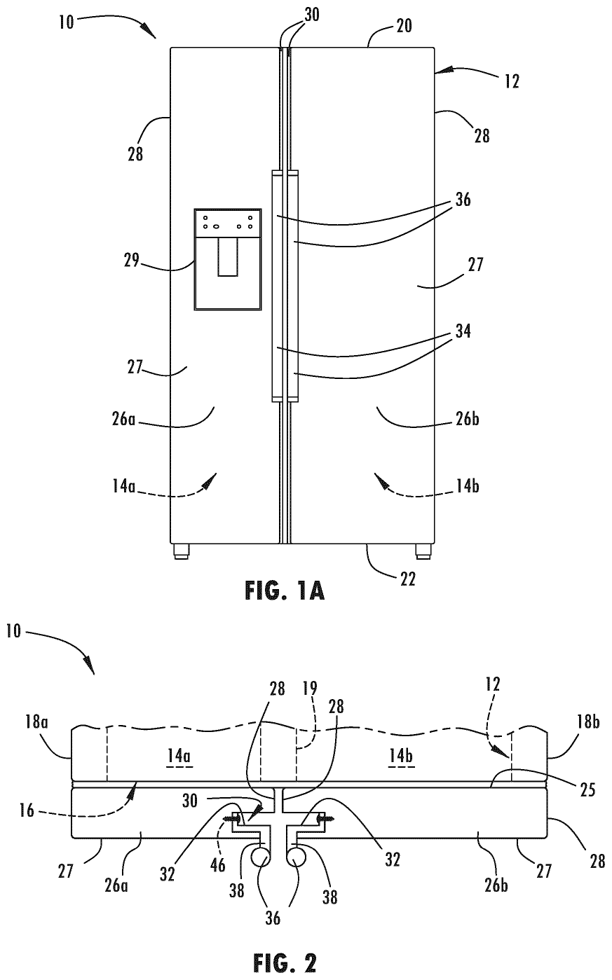

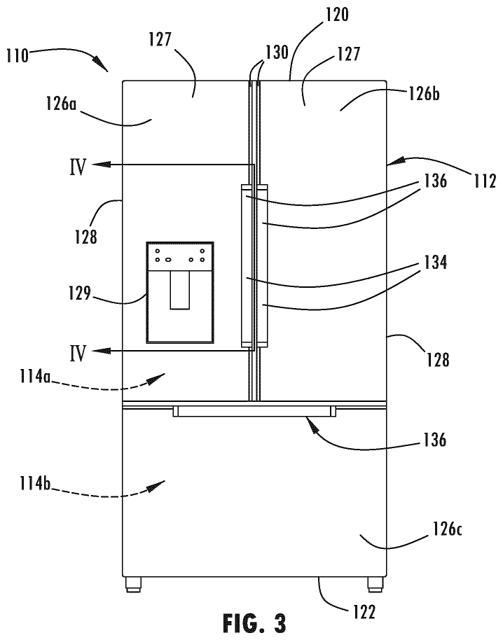

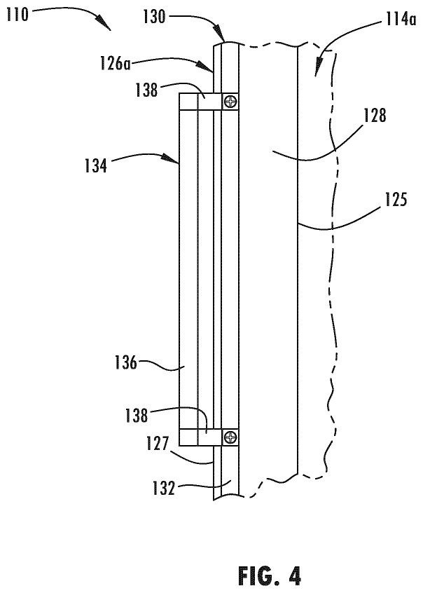

Referring now to the illustrated examples, refrigerator appliances 10, 110 (FIGS. 1 and 3) are common household appliances that include a cabinet 12, 112 (FIGS. 2 and 4) that defines at least one interior compartment 14a, 14b, 114a, 114b for storing food, beverages, and the like in a cold or chilled environment. The interior compartment 14a, 14b, 114a, 114b has an opening 16, 116 in the front side of the cabinet that is used to access food items stored in the interior compartment. As shown in FIG. 1, the cabinet 12, 112 is defined vertically between a top wall 20 and a bottom wall 22 that are parallel to each other and contained laterally in a width direction between side walls 18a, 18b that are parallel to each other. The depth of the cabinet is defined between a rear wall 24 and the front opening 16 (FIG. 2), or in other words, the depth is defined as the depth dimension of the top wall 20, bottom wall 22, and/or side walls 18a, 18b. The side walls 18a, 18b and the rear wall 24 extend vertically between the top and bottom walls 20, 22. Likewise, the top and bottom walls 20, 22 extend horizontally between the side walls 18a, 18b. In some examples, the cabinet is divided by interior walls, such as to provide multiple interior compartments. As shown in FIG. 2, a vertical interior wall 19 may be provided in the cabinet to provide a side-by-side style refrigerator, defining a freezer compartment 14a on one side and a refrigerator compartment 14b on the other side of the interior wall. In additional examples, a horizontal interior wall may be provided in the cabinet to provide an upper refrigerator compartment 114a and a lower freezer compartment 114b, such as shown in FIGS. 3-6. Similarly, a horizontal interior wall may be provided in a bottom mount refrigerator, a top mount refrigerator, a freezer appliance, and/or a French door refrigerator (FIG. 3).

As shown in FIGS. 1 and 2, a side-by-side refrigerator 10 has two doors 26a, 26b rotatably mounted to the cabinet 12 to enclose the front opening 16 at each of the respective interior compartments 14a, 14b. In some examples, the doors are rotatably mounted to the side walls 18a, 18b of the cabinet 12 with hinges that pivot the doors 26a, 26b between an open position and a closed position, such as shown in FIGS. 1 and 2. In some examples, the hinges are mounted to the top and bottom walls for the doors to similarly pivot about an axis that extends along an area proximate a front edge of the side walls. In the open position, the doors 26a, 26b are pivoted outward away from the interior compartment to the allow access to the respective interior compartment 14a, 14b. In the closed position, the doors 26a, 26b are substantially perpendicular to the side walls 18a, 18b and substantially parallel to the rear wall 24 to encloses the opening, such as in a sealed manner that prevents air exchange between the interior compartment and the exterior of the refrigerator cabinet 12. For such a side-by-side refrigerator 10, each door 26a, 26b may provide a substantial seal around the opening of the respective compartment 14a, 14b covered by the individual door. In additional examples, a single refrigerator door may enclose more than one compartment and a single refrigerator door may partially conceal an opening of a compartment in a closed position, such that other closed door may be needed to enclose such an opening.

As further shown in FIGS. 1-2, each door 26a, 26b is defined as a door body that has an inner surface 25 facing the interior compartment 14a, 14b, an outer surface 27 opposite the inner surface 25, and a peripheral edge surface 28 between the inner surface 25 and the outer surface 27. The peripheral edge surface 28 may surround the door, such that it may be substantially parallel to the corresponding outer surfaces of the top wall 20, bottom wall 22, and side walls 18a, 18b. However, some portions of the edge surface may be interrupted, such as at the hinge connection area of the respective door. Further, in some examples, the outer surface 27 of the door may be planar or curved, such as to provide an outward protruding curvature. The outer surface 27 may also be interrupted, such as with a water and ice dispenser 29 (at door 26a shown in FIGS. 1 and 1A) or a display or other user interface or the like.

As shown in FIG. 1, the inner edge or inner portion of the peripheral edge surface 28 of each door 26a, 26b is provided with a pocket handle 30. The pocket handle may extend at least partially along the peripheral edge surface of the door. In the example shown in FIG. 1, the pocket handle 30 extends vertically along the entire vertical extent of the inner edge of the doors 26a, 26b. The pocket handle 30 shown in FIGS. 1 and 2 extends laterally into the door body in a width direction of the door and refrigerator cabinet. The pocket handle 30 thereby defines a recessed surface 32 between the inner and outer surfaces 25, 27 of the door. In additional examples, the pocket handle may be reversed in orientation, such that it is accessible from the front of the door and may extend inward toward the center of the respective door or outward toward the nearest vertical edge. Also, in some examples, a pocket handle may extend partially along the peripheral edge surface of the door.

The pocket handles 30 have functional utility alone and can be desirable to provide a gripping area along the entire or substantial portion of the vertical extent of a door, such as to accommodate users of all heights and/or preferred gasping positions. Also, pocket handles 30 typically have high durability due to the relatively integrated construction with the door body. Further, pocket handles 30 minimize obstructions extending forward from the front exterior surface of the refrigerator doors, which can be beneficial in kitchen design and for shipping and assembly purposes. However, a pocket handle alone can be difficult to operate and grasp in some situations, such as when holding objects with both hands and needing to open the doors with reduced capability to insert a hand or finger into a pocket handle. Also, some appliances packages are designed to have outward protruding handles that are similar in shape and appearance between the appliance in the package, such as ovens, dishwashers, microwaves, ice makers, and the like. According, the refrigerator can benefit from having a handle assembly 34 attached to and extending at least partially along the peripheral edge of each refrigerator door 26a, 26b, where the handle assembly 34 has a handle portion 36 protruding forward and being spaced from the front, outer surface of the door.

As shown in FIGS. 1 and 2, the refrigerator 10 has a handle assembly 34 disposed along an intermediate extent of the vertical length of each pocket handle 30, thereby having a shorter effective length than the pocket handles. As shown in FIG. 1, the handle portion 36 of each handle assembly 34 terminates vertically at ends that expose upper and lower sections of the pocket handle 30. The handle portions 36 extend vertically along the central vertical area of the door, such as adjacent to the water and ice dispenser 29. Additional details, such as the mounting and attachment configuration, for the handle assembly are shown and described in the related example shown in FIGS. 3-6 and are applicable to the example shown in FIGS. 1 and 2.

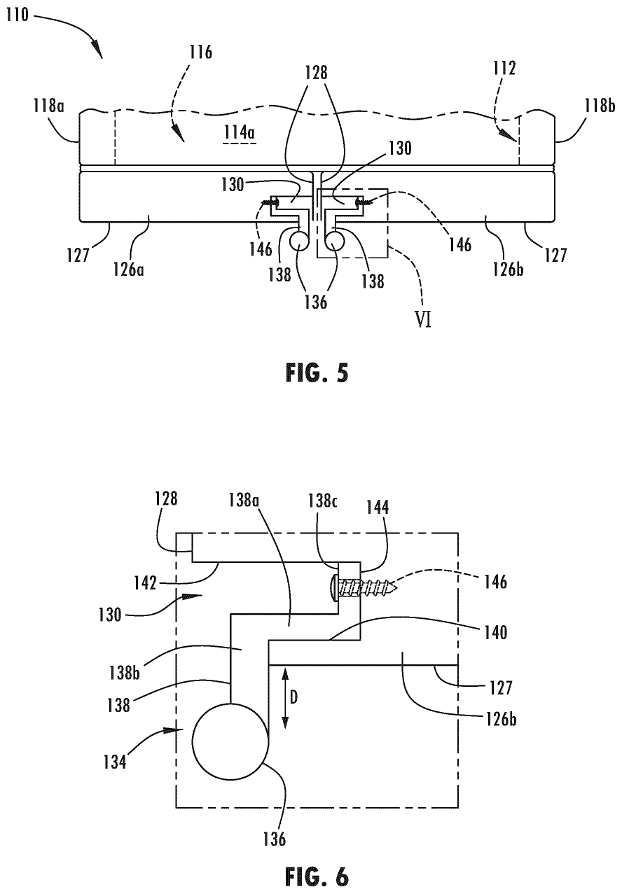

As shown in FIGS. 3-6, a French door refrigerator 110 has two doors 126a, 126b rotatably mounted to the cabinet 112 to enclose the front opening 116 of a first interior compartment 114a and a freezer door 126c slidably mounted to the cabinet to enclose the front opening of a second interior compartment 114b. The freezer door 126c forms the front face of a drawer that slides into the second interior compartment 114b or freezer compartment, below the illustrated first interior compartment 114a. The doors 126a, 126b are mounted or otherwise supported by the cabinet in a manner to pivot at or near the front edge of the side walls 118a, 118b (FIG. 5) of the cabinet 112, so as to move the doors 126a, 126b between an open position and a closed position, such as shown in FIGS. 3-5. In the open position, the doors 126a, 126b are pivoted outward away from the interior compartment to the allow access to the interior compartment 114a. In the closed position, the doors 126a, 126b are substantially perpendicular to the side walls 118a, 118b and substantially parallel to the rear wall to encloses the opening, such as in a sealed manner that prevents air exchange between the interior compartment and the exterior of the refrigerator cabinet 112. For such a French door refrigerator 110, each upper doors 126a, 126b may partially conceal the opening 116 of the refrigerator compartment in a closed position, such that both adjacent doors 126a, 126b must be closed to fully enclose and seal the opening 116.

As shown in FIGS. 3-5, each door 126a, 126b, 126c is defined as a door body that has an inner surface 125 facing the respective interior compartment 114a, 114b, an outer surface 127 opposite the inner surface 125, and a peripheral edge surface 128 between the inner surface 125 and the outer surface 127. The peripheral edge surface 128 of each door generally may surround the perimeter of the front or outer surface 127 of each respective door 126a, 126b. The peripheral edge surface 128 may be substantially parallel to at least one of the adjacent and corresponding outer surfaces of the top wall, bottom wall, or side walls 118a, 118b of the cabinet. The inner edge or inner portion of the peripheral edge surface 128 of each door 126a, 126b is provided with or includes a pocket handle 130. The pocket handle 130 extends vertically along the peripheral edge surface of the door, and in this example also extends along the entire vertical extent of the inner edge of the doors 126a, 126b. The pocket handle 130 extends laterally into the door body in a width direction of the door and refrigerator cabinet. The pocket handle 130 thereby defines a recessed surface 132 between the inner and outer surfaces 125, 127 of the door.

As shown in FIGS. 3-6, the refrigerator 110 has a handle assembly 134 disposed along an intermediate extent of the vertical length of each pocket handle 130, thereby having a shorter effective length than the pocket handles 130. The handle portion 136 of each handle assembly 134 terminates vertically at ends that expose upper and lower sections of the pocket handle 130. Also, the handle assembly 134 includes a mounting portion 138 that is coupled to the ends of the handle portion 136 and is coupled with the recessed surface 132 of the pocket handle 130. The mounting portion 138 extending outward from the interior compartment of the refrigerator and supports the handle portion 136 at a spaced distance outward from the outer surface 127 of the door 126a.

As shown in FIG. 4, each handle assembly 134 includes two mounting portions 138 that are attached at the top and bottom ends of the handle portion 136. In additional examples, a single mounting portion may be provided or additional mounting portions may be provided, such as for different handle designs. The distal ends of the mounting portions 138 may be attached to the handle portion 136 in various means and forms of attachment, such as with integrated formation, insert molding, welding, adhesive, fasteners, and combinations thereof and the like. The proximal ends of the mounting portions 138 are attached to the recessed surface 132 of the pocket handle 130.

As shown in FIGS. 5 and 6, the recessed surface 132 of the pocket handle 130 includes a front internal surface 140 along an edge portion of a front wall of the door body that faces rearward on the door 126a, 126b. The recessed surface 132 also includes a rear internal surface 142 along an intermediate wall of the door body that faces forward on the door 126a, 126b. The width of the front internal surface 140, as shown in FIGS. 5 and 6, is less than a width of the rear internal surface 142, which positions an edge of the front wall inboard from the peripheral edge surface 128. This also makes the outer part of the rear internal surface 142 visible from the front of the door, such as shown in FIG. 3.

In addition, as shown in FIGS. 5 and 6, the recessed surface 132 includes a connecting internal surface 144 between the front and rear internal surfaces 140, 142. The mounting portion 138 of the handle assembly has a mounting flange 138c and a fastener 146 that extends through the mounting flange and into the connecting internal surface 144 and into the door body. As shown in FIG. 6, the mounting portion 138 of the handle assembly 134 includes an internal section 138a that extends in a width direction of the door body along the front internal surface 140 of the pocket handle 130. The mounting portion 138 also includes an external section 138b that extends forward from the internal section 138a adjacent to and beyond an edge of the front wall. As further shown in the example in FIG. 6, the external section 138b of the mounting portion 138 is disposed slightly inboard in the width direction from the peripheral edge surface of the door body. In additional examples the external section of the mounting portion may be angled inboard toward the center of the attached respective door, such as to move the handle portions away from each other.

As shown in FIGS. 3-6, the mounting portion supports the handle portion 136 at a spaced distance D outward from the front, outer surface 127 of the refrigerator door 126b. In additional examples, the spaced distance may be greater or less, such that the handle portion may overlap with the front, outer surface at some sections of the handle portions, such as at its ends. As also shown in FIGS. 3-6, the handle portion 136 is substantially cylindrical or tubular shaped along its length. In additional examples, the handle portion may have different shapes, such as an oval cross-sectional shape or with gripping features, such as finger indentations. Also, it additional examples may be curved along its length or have different shapes along its length.

Additional variations and features will be readily appreciated by those of skill in the art and can be practiced with the above described alternative implementations without departing from the scope of the disclosure.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature; may be achieved with the two components (electrical or mechanical) and any additional intermediate members being integrally formed as a single unitary body with one another or with the two components; and may be permanent in nature or may be removable or releasable in nature, unless otherwise stated.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” “inboard,” “outboard” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A door assembly for a refrigerator appliance, the door assembly comprising:
a door body having an inner surface configured to face rearward toward an interior compartment of the refrigerator appliance, an outer surface opposite the inner surface, and a peripheral edge surface between the inner surface and the outer surface;
a pocket handle extending along at least a portion of the peripheral edge surface of the door body, the pocket handle defining a recessed surface; and
a handle assembly having a handle portion and a mounting portion coupled with the recessed surface of the pocket handle, the mounting portion extending forward and supporting the handle portion at a spaced distance forward from the outer surface of the door body.

2. The door assembly of claim 1, wherein the handle portion of the handle assembly extends along a section of a length of the pocket handle.

3. The door assembly of claim 1, wherein the recessed surface of the pocket handle comprises a front internal surface along an edge portion of a front wall of the door body that faces rearward on the door body.

4. The door assembly of claim 3, wherein the recessed surface of the pocket handle comprises a rear internal surface along an intermediate wall of the door body that faces forward on the door body.

5. The door assembly of claim 4, wherein a width of the front internal surface is less than a width of the rear internal surface to position an edge of the front wall inboard from the peripheral edge surface of the door body.

6. The door assembly of claim 4, wherein the recessed surface of the pocket handle comprises a connecting internal surface between the front and rear internal surfaces, and wherein the mounting portion of the handle assembly includes a fastener that extends through the connecting internal surface into the door body.

7. The door assembly of claim 4, wherein the mounting portion of the handle assembly includes an internal section that extends in a width direction of the door body along the front internal surface of the pocket handle.

8. The door assembly of claim 7, wherein the mounting portion of the handle assembly includes an external section that extends forward from the internal section adjacent to and beyond an edge of the front wall.

9. The door assembly of claim 8, wherein the external section of the mounting portion of the handle assembly is disposed inboard in the width direction from the peripheral edge surface of the door body.

10. A refrigerator door handle for a refrigerator appliance, the refrigerator door handle comprising:
a handle portion configured for a user to grasp to open a refrigerator door; and
a mounting portion having an mount surface configured to attach in a pocket handle on a peripheral edge of the refrigerator door, the mounting portion extending outward from the mount surface a distance configured to support the handle portion at a spaced distance outward from an outer surface of the refrigerator door.

11. The refrigerator door handle of claim 10, wherein the mounting portion includes an internal section that extends in a width direction of the refrigerator door along a front internal surface of the pocket handle.

12. The refrigerator door handle of claim 11, wherein the mounting portion includes an external section that extends forward from the internal section adjacent to and beyond an edge of the outer surface of the refrigerator door.

13. The refrigerator door handle of claim 12, wherein the external section of the mounting portion is disposed inboard in the width direction from the peripheral edge of the refrigerator door.

14. A refrigerator appliance comprising:
a cabinet defining an interior compartment with an opening;
a door movable mounted to the cabinet and operable to at least partially conceal the opening in a closed position, the door having an inner surface facing the interior compartment, an outer surface opposite the inner surface; and a peripheral edge surface between the inner surface and the outer surface;
a pocket handle extending at least partially along the peripheral edge surface of the door, the pocket handle defining a recessed surface; and
a handle assembly having a handle portion and a mounting portion coupled with the recessed surface of the pocket handle, the mounting portion extending outward from the interior compartment and supporting the handle portion at a spaced distance outward from the outer surface of the door.

15. The refrigerator appliance of claim 14, wherein the handle portion of the handle assembly extends along a section of a length of the pocket handle.

16. The refrigerator appliance of claim 14, wherein the recessed surface of the pocket handle comprises:
a front internal surface along an edge portion of a front wall of the door that faces rearward on the door, and
a rear internal surface along an intermediate wall of the door that faces forward on the door, and
wherein a width of the front internal surface is less than a width of the rear internal surface.

17. The refrigerator appliance of claim 16, wherein the recessed surface of the pocket handle comprises a connecting internal surface between the front and rear internal surfaces, and wherein the mounting portion of the handle assembly engages the connecting internal surface.

18. The refrigerator appliance of claim 14, wherein the mounting portion of the handle assembly includes an internal section that extends in a width direction of the door and an external section that extends forward from the internal section and beyond the outer surface of the door.

19. The refrigerator appliance of claim 14, wherein the handle portion comprises a cylindrical shape.

20. The refrigerator appliance of claim 14, wherein the mounting portion comprises a pair of brackets that connect opposing ends of the handle portion to the recessed surface of the pocket handle.
